(19) United States
(12) Patent Application Publication
(10) Pub. No.: US 2003/0108348 A1
(43) Pub. Date: Jun. 12, 2003

(54) Lens assembly having aperture mounted on front end thereof

(76) Inventor: Li-Chen Huang, Taipei Hsien (TW)

Correspondence Address: BROWDY AND NEIMARK, P.L.L.C., 624 NINTH STREET, NW, SUITE 300, WASHINGTON, DC, 20001-5303, US

(21) Appl. No.: 10/003,297

(22) Filed: Dec. 6, 2001

(51) Int. Cl. G03B 9/02

(52) U.S. Cl. 396/505

(57) ABSTRACT

A lens assembly comprises an aperture and a lens group consisting of a first, a second, a third, and a fourth lens element. The first lens element is a bi-convex lens element disposed at the front side of the lens assembly. The second lens element is a bi-concave lens element. The third lens element is a meniscus lens element with its convexity facing the rear side of the lens assembly, and the fourth lens element is a bi-convex lens element disposed at the rear end of the lens assembly. The aperture is disposed on the front side of the first lens element.

### FIELD OF THE INVENTION

The present invention relates generally to a camera lens assembly with a fixed focal length, and more particularly to the lens assembly for use on digital camera, PC camera, cellular telephone, palmtop computer and other digital imaging products.

### BACKGROUND OF THE INVENTION

Conventional film type cameras and digital cameras record graphic representations of objects through a still image capturing apparatus. A small lens assembly is installed in anterior to the picture recording surface of the still image capturing apparatus and is utilized to convert the image of an external object into a reproduction on the picture recording surface. Since the exterior structural dimensions of such small lens assemblies are constantly meeting requirements for further reduction, light travelling to the picture recording surface of the still image capturing apparatus undergoes a possible decrease in its angle of depression. In other words, the exit pupil position of the photographic lens may no longer be inaccurate. To adapt to the development requirements of compact digital cameras, PC cameras, and palmtop computers, the dimensions of the still image capture elements have been reduced by ⅕ to 1/7. As a result, photographic lens assemblies had to be additionally diminished in size and matching the view finder focus relative to the distance from the imaging surface to the exit pupil position was difficult. Similarly, optical properties adjustment was also problematic. In the present technology, the still imaging apparatus is often situated on the image surface of film and digital cameras and, furthermore, the still imaging apparatus are required to be ultra small. To meet the said objectives, the imaging lens typically consists of four or five lens elements and an aperture disposed between the lens elements. The inadequacy of such an arrangement is that when an aperture is placed between the lens elements, a very large space is left at its front or rear surface. This increases the overall dimensions of the system, resulting in physically larger lenses and, furthermore, major compensating difficulties during assembly.

### SUMMARY OF THE INVENTION

The primary object of the present invention is to provide a lens assembly of small physical dimensions that is easy to install on the compact digital cameras, PC cameras, cellular telephones, palmtop computers and other small form factor digital imaging products.

To achieve the above mentioned objective, the lens assembly of the present invention comprises an aperture and a lens group consisting of a first, a second, a third, and a fourth lens element. The first lens element is a bi-convex lens element disposed at the front side of the lens assembly. The second lens element is a biconcave lens element. The third lens element is a meniscus lens element with its convexity facing the rear side of the lens assembly, and the fourth lens element is a bi-convex lens element disposed at the rear end of the lens assembly. The aperture is disposed on the front side of the first lens element.

Following utilization of the above mentioned structure, the physical dimensions of the lens assembly becomes smaller (total length is reduced); furthermore, the invention herein is easy in assembly, reduces optical distortion, is of a simple structure, and affords optimal imaging properties; while designed for applications such as digital cameras, cellular telephones, PC cameras, palm top computers, and other small form factor digital imaging products, the invention herein is also suitable for utilization with microlens-equipped scanning sensors.

### BRIEF DESCRIPTION OF THE DRAWINGS

FIG. 1 is a schematic axial section view a preferred embodiment of the lens assembly of present invention; and

FIG. 2 is an axial section view through the embodiment of FIG. 1 mounted in a lens barrel.

### DETAILED DESCRIPTION OF THE INVENTION

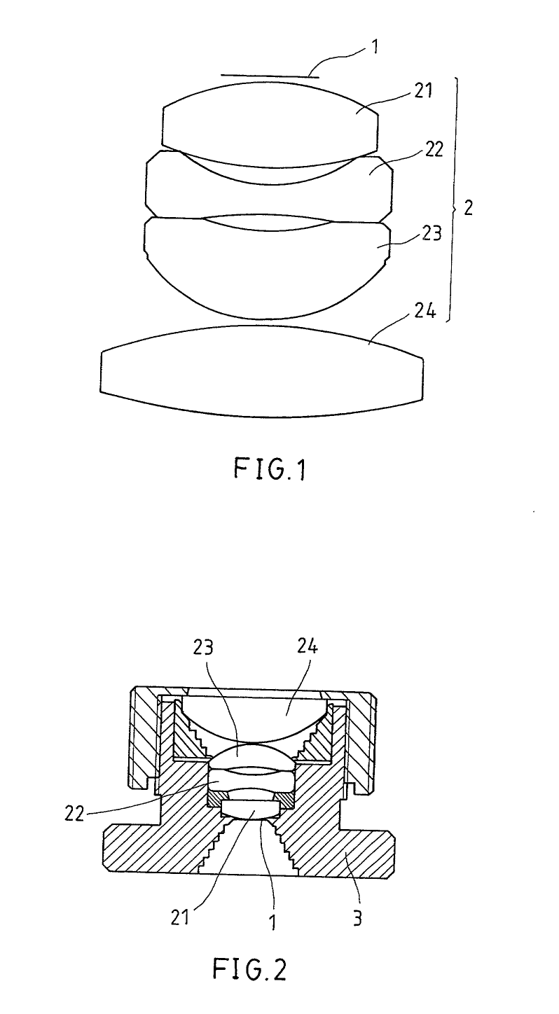

As shown in FIG. 1, the lens assembly of the preferred embodiment of present invention is comprised of an aperture 1 and a lens group 2. The lens group consists of a first, a second, a third, and a fourth lens element disposing one by one from the front side to the rear side of the lens assembly. The first lens element 21 is a bi-convex lens element disposed at the front side of the lens assembly. The second lens element 22 is a biconcave lens element. The third lens element 23 is a meniscus lens element with its convexity facing the rear side of the lens assembly. The fourth lens element 24 is a bi-convex lens that is disposed at the rear end of the lens assembly. The aperture 1 is disposed on the front side of the first lens element 21.

As indicated in FIG. 2, the lens assembly is mounted in a lens barrel 3.

What is claimed is:

1. A lens assembly comprising:
a lens group having a first, a second, a third, and a fourth lens element which are disposed one by one from the front side to the rear side of the lens assembly, said first lens element being a bi-convex lens element disposed at the front side of the lens assembly, said second lens element being a bi-concave lens element, said third lens element being a meniscus lens element with its convexity facing the rear side of the lens assembly, and the fourth lens being a bi-convex lens element disposed at the rear end of the lens assembly; and
an aperture disposed on the front side of the first lens element.
